(19) United States
(12) Patent Application Publication
(10) Pub. No.: US 2008/0250502 A1
(43) Pub. Date: Oct. 9, 2008

(54) Software Checking

(75) Inventor: Joan Bosch Sole, Barcelona BA (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/915,944

(22) PCT Filed: May 30, 2006
(86) PCT No.: PCT/EP2006/062734

§ 371 Date: Nov. 29, 2007

(30) Foreign Application Priority Data
Jun. 1, 2005 (GB) 0511056.4

(51) Int. Cl. G06F 21/00

(52) U.S. Cl. 726/23

(57) ABSTRACT

A method of checking the integrity of a software component comprises: selecting a checking algorithm 50 from a plurality of checking algorithms in a pseudo-random manner; performing the algorithm on the component 22 to produce a checking code that is dependent on the integrity of the component and the algorithm selected; and comparing the checking code with a reference code 52 to check the integrity of the component.

### FIELD OF THE INVENTION

The present invention relates to computer systems, and in particular the checking of software components of computer systems to ensure that they have not been manipulated or modified in an unauthorized manner.

### BACKGROUND TO THE INVENTION

Many software languages, when compiled, produce native code that is a large quantity of data that is very difficult, or effectively impossible, to analyse. This means that programs written in these languages are relatively hard to decompile and interpret. This makes them difficult to modify in an unauthorized manner. Other languages have more structure when compiled, which makes them much easier to decompile, and therefore also much easier to modify or ‘hack’. Java is an example of a language that, when compiled, has a very visible structure, and is therefore susceptible to hacking. The present invention is therefore particularly useful for Java language applications.

It is known, for example from US 2005/0027987, to use hash codes in computer security systems.

### SUMMARY OF THE INVENTION

The present invention provides a method of checking the integrity of a software component, the method comprising: selecting a checking algorithm from a plurality of checking algorithms in a pseudo-random manner; performing the algorithm on the component to produce a checking code that is dependent on the integrity of the component and on the algorithm selected; and comparing the checking code with a reference code to check the integrity of the component.

In some embodiments, the software component is checked when it is loaded for running. In some embodiments the checked component includes a plurality of sub-components each of which has a check code associated with it. In some embodiments the software component is a Java component. In some embodiments the checking code is produced using hash codes from the sub-components.

In some embodiments the method includes checking a part of the software component that comprises a record of operations performed in running the component. In some embodiments said part of the software component is a call stack.

The present invention further provides a system for checking the integrity of a software component, the system being arranged to: select a checking algorithm from a plurality of checking algorithms in a pseudo-random manner; perform the algorithm on the component to produce a checking code that is dependent on the integrity of the component and on the algorithm selected; and compare the checking code with a reference code to check the integrity of the component.

In some embodiments the system further comprises a checking component that is a further software component arranged to select the checking algorithm. In some embodiments the checking component is written in a different language from the checked component. In some embodiments said different language is arranged to be compiled to form native code.

In some embodiments the system is a client/server system wherein the server is arranged to: receive a request for a service from the client; receive the checking code associated with the request; analyse the checking code thereby to check the integrity of the software component on the client, and determine whether or not to provide the service on the basis of the checking code.

In some embodiments the server system is arranged to send the checking component to the client. In some embodiments the server is arranged to cause different checking components to be run in response to separate requests for a service.

The present invention further provides a data carrier carrying data arranged, when run on a computer system, to cause the computer system to perform the method of the invention.

The present invention further provides a data carrier carrying data arranged, when run on a computer system, to cause the computer system to operate as the system of the invention.

The data carrier can comprise, for example, a floppy disk, a CDROM, a DVD ROM/RAM (including +RW, −RW), a hard drive, a non-volatile memory, any form of magneto optical disk, a wire, a transmitted signal (which may comprise an internet download, an ftp transfer, or the like), or any other form of computer readable medium.

Preferred embodiments of the present invention will now be described by way of example only with reference to the accompanying drawings.

### BRIEF DESCRIPTION OF THE DRAWINGS

FIG. 1 is a schematic system diagram of a server and client system according to an embodiment of the invention;

FIG. 2 is a flow diagram showing operation of the system of FIG. 1 in a method according to an embodiment of the invention; and

FIG. 3 is a schematic system diagram of a server and client system according to a second embodiment of the invention.

### DESCRIPTION OF THE PREFERRED EMBODIMENTS

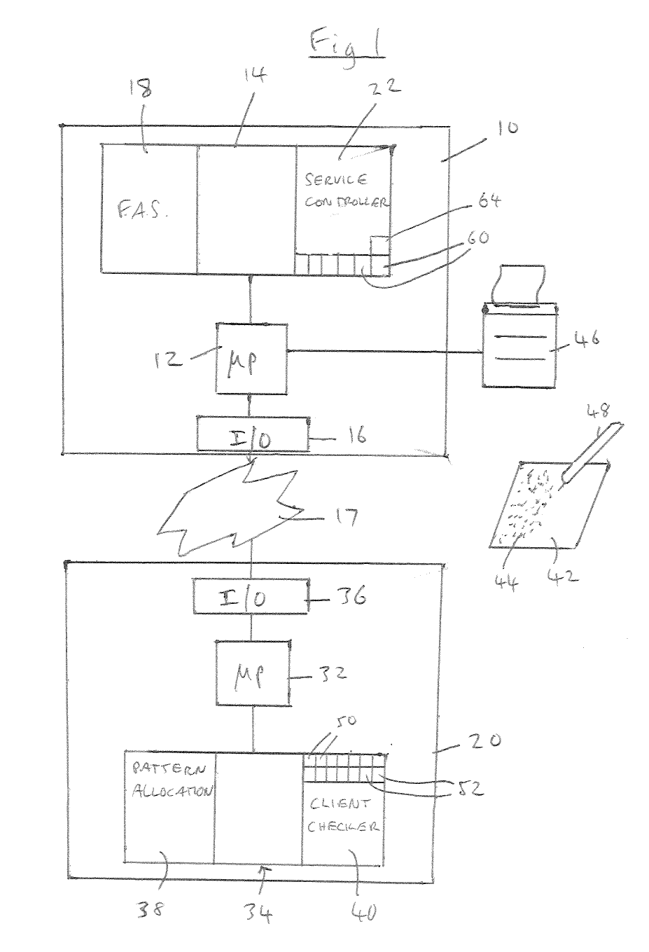

Referring to FIG. 1, a client system 10 comprises a processor 12, memory 14, and input/output devices 16 that enable it to communicate over a network 17. The memory 14 has a number of software applications stored on it, including a form automation system 18 and a service controller 22. The form automation system (FAS) 18 is arranged to create and print forms 42 having data encoding pattern 44 printed on them, by a printer 46 as shown in FIG. 1. The pattern 44 is arranged to code positional data and is readable by a pen 48. This enables the pen 48 to capture and record the positions of marks made on the forms by the pen 48, which in turn enables the forms 42 to be processed when they are filled in using the pen 48. Each time a new form is printed, the client system needs to contact a server system 20 to obtain a unique area of pattern that can be associated with that form. A service controller 22 is a further software component stored in the memory 14 of the client 10, and is arranged to control communications between the client 10 and server 20. In particular the service controller is arranged to record the amount of pattern that has been obtained by the client 10 from the server 20, to control payment for the pattern, and to provide proof of payment to the server 20 so that the server 20 can ensure that all pattern that it sends to the client 10 is paid for.

The server system 20 comprises a processor 32, memory 34, and input/output devices 36 that enable it to communicate over a network. The server system memory 34 has a number of software applications stored on it, including a pattern allocation module 38 and a client checker module 40. The pattern allocation module 38 is arranged to receive requests for areas of pattern from the client system 10, together with an identification of the particular instance 42 of the form that is to be printed by the client system 10 on the printer 46, to select appropriate areas of pattern from a total pattern space, and to transmit the areas of pattern to the client so that they can be printed on the forms. It is also arranged to record which areas of pattern have been allocated to which forms, so that pen strokes made on the forms can be processed. The client checker module 40 is arranged to cooperate with the pattern allocation module 38 to ensure that the pattern allocation module only allocates pattern in response to a request from a client that meets specific criteria. The client checker module 40 is written in a non-java compiled language, in this case C++.

The client checker module 40 has defined within it a plurality of client checking components 50, together with respective check codes 52. Each client checking component 50 is an executable software component that can be run on the client to check data stored on, or associated with, the client, and return to the server a check code, which depends on the data being checked. The client checking components 50 are in the form of Java classes, e.g. X.class, Y.class etc. The client checker is arranged to send to the client one of the client checking components 50, and when it is run on the client, to check the check code that is returned against the appropriate check code 52 stored in its memory. The data to be checked can be a simple piece of data, such as an Ethernet card number, or can be something more complex, such as a complete software program component.

In this case, the data to be checked is the code of the service controller software component 22. The service controller 22 is written in Java, which has a number of features that make it particularly suitable for this invention. The Java program 22 is made up of a number of components, known as classes 60. The classes are executable files of the from A.class, B.class etc. Each of the classes 60 has a hash code associated with it. The hash code is produced when a hash code algorithm, which is a standard feature of the Java language, is run for that class. The hash code that is produced by the hash code algorithm is dependent on the binary code of the class. An example of a suitable hash code algorithm is Adler32. The service controller 22 also includes a call stack 64. This again is a standard Java component that includes a record of which of the classes 60 have been executed and in which order. The call stack therefore keeps a record of the sequence of steps in the operation of the service controller, and the times and order in which they are performed. This includes the sequence of operations that are carried out by the client 10 in requesting the service from the server 20. At any one time, therefore, the service controller 22 includes a portion of binary code that defines the processes that the service controller can carry out, i.e. the classes 60 themselves, and a portion of binary code that records the latest processes or method steps that the service controller 22 has carried out, i.e. the call stack 64.

The check codes 52 stored on the server system are each arranged to correspond to the result that is produced when the respective checking component 50 is run on some of the binary code making up the service controller 22. In this case because the Java language means that the service controller is formed from a number of Java classes, the checking component is arranged to check the hash codes of each of the java classes that make up the service controller. It does this using an algorithm that generates a checking code from the hash codes. The algorithm can be arranged to check the hash codes of all of the classes of the service controller, or just those from selected classes that are deemed to be the most significant. The algorithm is arranged to be run by the client operating system as it loads the binary of the Java classes making up the service controller. The algorithm runs the hash code algorithm to produce the hash codes of the Java classes as they are loaded into RAM for running. As the service controller is written in Java, the classes are loaded dynamically in a sequence. The checking component is therefore arranged to check the classes dynamically, each class being checked as it is loaded to produce a respective hash code. The hash codes are stored in a sequence. The checking component algorithm then performs further operations on the sequence of hash codes. This ensures that the version of the service controller that is checked is the version that is actually loaded and run.

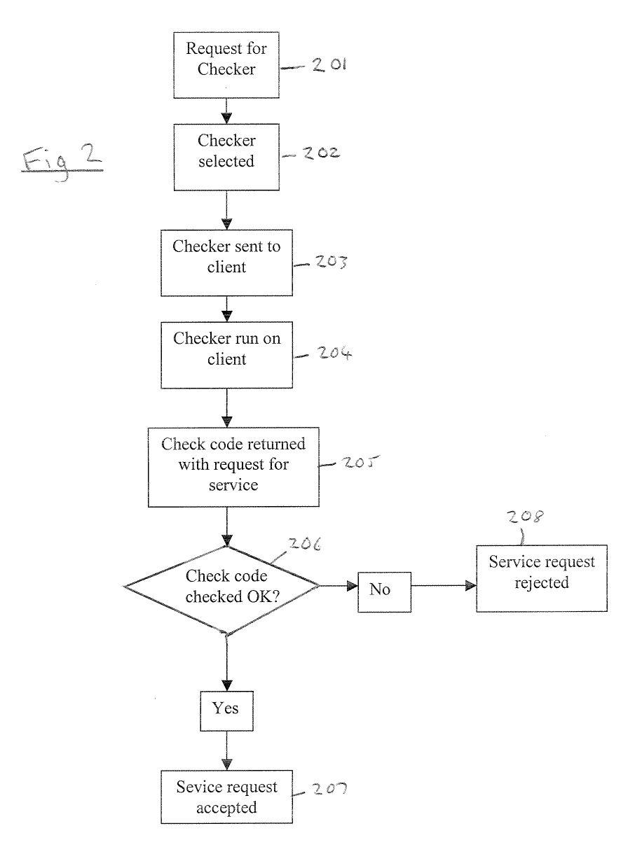

Referring to FIG. 2, for the client to request a service from the server, it is first arranged to submit a request to the server at step 201. This is not in this case specific to the service requested, but it could be. The request simply indicates that the client wishes to request a service. The client checker 40 responds to this request by selecting one of the checking components 50 in a pseudo-random manner at step 202, and sending it to the client at step 203. The client then runs the checking component at step 204 which checks the classes of the service controller 22 dynamically, each class being checked when it is loaded as the service controller generates the request for a specific service. The checking component runs the hash code algorithm for each of the classes when it is loaded, and stores the hash codes in a sequence determined by the order in which they are run. When the sequence is complete, the checking component generates a corresponding checking code from the sequence of hash codes. The last part of the hash code sequence is generated from the call stack, the contents of which will depend on the order in which the classes have been run. The checking code is then returned by the service controller at step 205 to the server as the first part of the service request.

The client checker module 40 is arranged to check the returned check code against the relevant stored check code at step 206. If the received check code corresponds to that stored in the client checker 40, then this is taken as an indication that the service controller has not been hacked, the request for the service is accepted and the service is provided as requested at step 207. If the received check code does not correspond with the stored check code, then the service request is rejected at step 208. The response of the server to detection of an invalid check code can vary depending on the system, and might include issuing an error message or warning.

The client checker module 40 also monitors the time between when it sends the checking component to the client, and when it receives the request for a service that includes the corresponding checking code. If the request comes back within a predetermined time from when the checking component was sent, then the request is accepted at step 207 and the requested service provided. If the request comes back outside the time limit then it is not accepted, and is instead rejected at step 208. This ensures that a hacker cannot obtain the constraint checker when it is sent, decompile it, generate the expected checking code, and use it to request the service.

In a single threaded environment, where the check code sent to the server 20 by the client 10 will always have been generated using the last checking component 50 that the server 20 has sent, the server can simply check the returned check code against the appropriate reference code it has stored. In a multi-threaded environment, where several invocations of one or more services can be requested at the same time, a further identifier is needed to indicate which checking component 50 the returned check code has been generated by. In order to achieve this, the client checker 40 sends out an identifier with the checking component. The checking component is arranged to return the identifier with the check code that it generates on the client. The identifier is generated or selected by a randomising process and associated with the checking component only when the checking component is sent by the server. Therefore the server keeps a record of which checking component the identifier is associated with, but it is not possible for a third party to identify the specific checking component from the identifier.

Because the checking component 50 operates as the service controller is being run this ensures that the service is only provided if the main portion of code making up the service controller 22 has not been modified in any way at the time when the request is made. It also ensures that the service will only be provided if the call stack 64 contains a record of a predetermined sequence of steps in the operation of the service controller. This ensures that, if the service controller has been hacked into, for example to try to interfere with its accounting functions to obtain services without paying, then the service will not be provided because the hash codes from the Java classes of the service controller 22, and hence the checking code generated from them will not correspond to their original form. It also ensures that, if the operation of the service controller 22 has been modified, for example to call the server 20 from an entry point that the server does not have under control, then the service will also not be provided, because the sequence of steps recorded in the call stack will not correspond to the normal expected sequence that should be followed when a service is requested.

Examples of the types of service that might cause the client checker module 40 to perform the checking operation would be the sending of an area of pattern to the client, or the provision of the identity of a destination to which pen stroke data should be sent by the client.

It will be appreciated that the time at which the client checker is run on the client is important in ensuring that the check is valid. In the example above, the checking is carried out when the software component being checked is loaded. This is particularly important with languages such as Java where the classes can be loaded from different locations, and may therefore not be stored together in memory on the client. However, in a modification to the embodiment described above, the server can be arranged to send a checking component to the client at regular intervals and to check the check code that is returned each time. Again the checking components sent are selected in a pseudo-random manner so they cannot easily be anticipated by a third party. In this case the software is not checked when it is loaded, but provided the correct check code is returned each time the client checker is run, and in particular provided the last check code returned before a request is made is correct, then the request for services from the client will be met by the server.

While the embodiment described above relates to a digital pen and paper system, it will be appreciated that the same checking process can be used in any client/server system and can enable the server to check the integrity or other constraints of the client software before providing a service to the client.

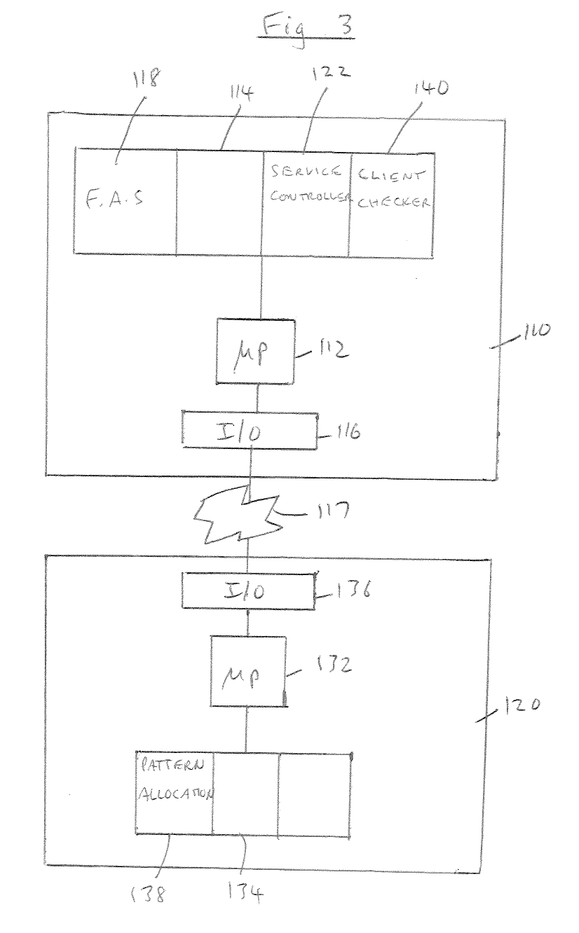

Referring to FIG. 3, a second embodiment of the invention will now be described. Components of the second embodiment corresponding to components of the first embodiment are indicated by the same reference numerals increased by 100. The client checker module 140 is, in this case, on the client 110. However in order to ensure that the client checker module 140 cannot easily be modified, it is written in a different language from other parts of the service controller 122, that language being harder to decompile and modify than the language of the those other parts. Specifically whereas most of the service controller is again written in Java, the client checking module is written in C. The client checking module 140 also includes the software arranged to perform one or more essential functions of the service controller 122. This means that the service controller can be considered as comprising two components, a first component written in Java, and a second part written in C. The Java part of the service controller cannot function without the C part. The client checker 140 also performs a similar function to the client checker in the embodiment of FIG. 1. Specifically when the service controller 122 needs to request a service from the server 120, the client checker 140 checks the Java classes making up the service controller 122 as it is making the request. Provided the check proves positive, the client checker performs its essential function relating to the request and the request is sent to the server. The server 120 is therefore not involved in the client checking process. However, if the Java part of the service controller 122 has been modified in any way, then the client checker will not enable the request for the service to be sent.

Again, it will be understood that this checking process can be applied to a very wide variety of software components, particularly but not exclusively those written mainly in Java, to check that the software component has not been hacked, or to ensure that, if the Java part of the program has been hacked, the program will not operate.

In a third embodiment of the invention the system is the same as that of FIG. 1, except that the service controller is not written in Java, but is written in another language. In this case that language is Fortran, but it could be any other compiled language such as C or C++. The binary code making up the service controller is recorded in bytes, each comprising a number of bits of data. In this case the client checkers cannot make use of the Java hash codes, and instead use algorithms that are arranged to identify the bytes of binary code that make up the parts of the service controller to be checked. As with the first embodiment, this can be achieved by checking the service controller software when it is loaded, and the checking components then produce a check code that is dependent on the binary code in all of the bytes of the service controller code. The exact form of the checking component is not important, and there are a number of check sum and similar algorithms that can be used. Clearly the check code will be made up of significantly less data then the binary code being checked, but the code checker is arranged to check each byte so that the final check code produced is dependent on all of the bytes. If any of the bytes is modified, then the probability that the check code will be unchanged is very small.

In the examples described above the checking components are stored in memory and selected by the client checker module in a pseudo-random manner. This might be done, for example, by generating a ‘random’ number and using that number to select one of the algorithms from a list. It will of course be understood that when the term ‘random’ is used in this context it will generally not refer to a truly random process, but to a pseudo-random process. The ‘random’ number generated will depend on one or more factors which are not truly random, but cannot easily be predicted. However, in a further embodiment, the checking components are selected from a larger group of possible checking components by effectively being generated when they are required in a pseudo-random manner. In this case the client checker has stored in it a number of basic algorithms. When an algorithm is required, a series of ‘random’ numbers are generated, which determine which of the basic algorithms will be used to make up the client checking component, and the order in which the basic algorithms will be combined in the client checking component. Clearly this allows the checking algorithm to be selected from a very large or infinite group of possible algorithms. In this case, as the client checking components are not generated until they are used, the resulting checking codes that they are expected to generate cannot be stored in advance. Instead the expected checking code for each checking component has to be generated by the client checker, for example from a copy of the service controller software code.

1. A method of checking the integrity of a software component, the method comprising:
selecting a checking algorithm from a plurality of checking algorithms in a pseudo-random manner;
performing the algorithm on the component to produce a checking code that is dependent on the integrity of the component and on the algorithm selected; and
comparing the checking code with a reference code to check the integrity of the component.

2. A method according to claim 1 wherein the software component is checked when it is loaded for running.

3. A method according to claim 1 wherein the checked component includes a plurality of sub-components each of which has a check code associated with it.

4. A method according to claim 3 wherein the software component is a Java component.

5. A method according to claim 3 wherein the checking code is produced using hash codes from the sub-components.

6. A method according to claim 1 including checking a part of the software component that comprises a record of operations performed in running the component.

7. A method according to claim 6 wherein said part of the software component is a call stack.

8. A system for checking the integrity of a software component, the system being arranged to:
select a checking algorithm from a plurality of checking algorithms in a pseudo-random manner;
perform the algorithm on the component to produce a checking code that is dependent on the integrity of the component and on the algorithm selected; and
compare the checking code with a reference code to check the integrity of the component.

9. A system according to claim 8 further comprising a checking component that is a further software component arranged to select the checking algorithm.

10. A system according to claim 9 wherein the checking component is written in a different language from the checked component.

11. A system according to claim 10 wherein said different language is arranged to be compiled to form native code.

12. A system according to claim 8 that is a client/server system wherein the server is arranged to:
receive a request for a service from the client;
receive the checking code associated with the request;
analyse the checking code thereby to check the integrity of the software component on the client, and
determine whether or not to provide the service on the basis of the checking code.

13. A system according to claim 12, wherein the server system is arranged to send the checking component to the client.

14. A system according to claim 12 wherein the server is arranged to cause different checking components to be run in response to separate requests for a service.

15. A data carrier carrying data arranged, when run on a computer system, to cause the computer system to perform the method of claim 1.

16. A data carrier carrying data arranged, when run on a computer system, to cause the computer system to operate as the system of claim 8.
